(19) United States
(12) Patent Application Publication
(10) Pub. No.: US 2008/0155013 A1
(43) Pub. Date: Jun. 26, 2008

(54) Methods And Systems For Providing For Responding Without At Least One Of Scripts And Cookies To Requests Based On Unsolicited Request Header Indications

(76) Inventor: Robert P. Morris, Raleigh, NC (US)

Correspondence Address: SCENERA RESEARCH, LLC, 111 CORNING RD., SUITE 220, CARY, NC, 27511, US

(21) Appl. No.: 11/613,527

(22) Filed: Dec. 20, 2006

(51) Int. Cl. G06F 15/16

(52) U.S. Cl. 709/203

(57) ABSTRACT

Methods and systems are described for providing for responding without at least one of scripts and cookies to requests based on unsolicited request header indications. In one aspect, a request is received from a client device. The request includes a header with an unsolicited indicator for indicating whether cookies and/or scripts are accepted by the client device in a response to the request. The header is processed for determining whether the cookies and/or scripts are accepted by the client device based on the indicator. A response to the request is generated with or without the cookies and/or scripts based on the determination. The generated response is sent to the client device.

### RELATED APPLICATIONS

This application is related to U.S. patent application Ser. No. ______, titled “Methods and Systems for Providing for Responding to Messages Without Non-Accepted Elements of Accepted MIME Types Based on Specifications in a Message Header,” filed on even date herewith, the entire disclosure of which is here incorporated by reference.

### BACKGROUND

There is common agreement that the use of client-side scripts in network retrieved content is a security and privacy threat to the clients and users of the clients that receive and execute scripts. While not as much of a security threat, cookies are clearly a privacy threat.

A number of client-side tools, typically plug-ins or browser core functionality; provide some support for controlling the use of scripts and cookies in a client. Examples include NoScript®, a Firefox® plug-in for controlling whether scripts from a particular domain or service provider can be executed on the client, and CookieSafe®, a Firefox® plug-in that similarly allows a user to set permissions on a site- or cookie-basis. These tools can require user interaction for each script source or cookie that does not have a configured permission.

Since many sites or their services fail to operate with the use of cookies and/or scripts, users of these tools find themselves enabling the use of cookies and/or scripts in order to get a site or service to operate without knowing the full impact of their actions. Further, the use of these tools communicates little feedback to site or service providers. Users are also subject to bugs in these tools or vulnerabilities. Users often don't know whether the plug-ins themselves are safe, since the sources of these tools are uncertified and unknown in many instances.

Accordingly, there exists a need for methods, systems, and computer program products for providing for responding without at least one of scripts and cookies to requests based on unsolicited request header indications.

### SUMMARY

Methods and systems are described for providing for responding without at least one of scripts and cookies to requests based on unsolicited request header indications. In one embodiment, a request is received from a client device. The request includes a header with an unsolicited indicator for indicating whether cookies and/or scripts are accepted by the client device in a response to the request. The header is processed for determining whether the cookies and/or scripts are accepted by the client device based on the indicator. A response to the request is generated with or without the cookies and/or scripts based on the determination. The generated response is sent to the client device.

In another embodiment, input that includes at least a portion of a URI is received at a client device. The at least a portion of the URI corresponds to a request-processing entity. A request based on the received input is generated that includes a header with an indicator for indicating whether at least one of cookies and scripts are accepted by the client device in a response to the request. The indicator is unsolicited by the request-processing entity. The generated request is sent to the request-processing entity for enabling the request-processing entity to process the header and determine based on the indicator whether the at least one of cookies and scripts are accepted by the client device.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a flow diagram illustrating a method for providing for responding without at least one of scripts and cookies to requests based on unsolicited request header indications according to an embodiment of the subject matter described herein;

FIG. 2A is a block diagram illustrating a system for providing for responding without at least one of scripts and cookies to requests based on unsolicited request header indications according to another embodiment of the subject matter described herein;

FIG. 2B is a block diagram illustrating a system for providing for responding without at least one of scripts and cookies to requests based on unsolicited request header indications according to another embodiment of the subject matter described herein; and

FIG. 3 is a flow diagram illustrating a method for providing for responding without at least one of scripts and cookies to requests based on unsolicited request header indications according to another embodiment of the subject matter described herein.

### DETAILED DESCRIPTION

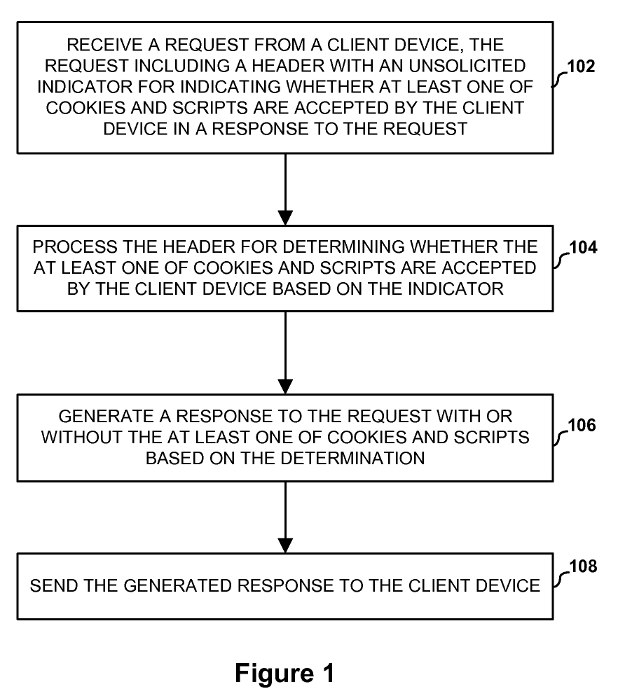

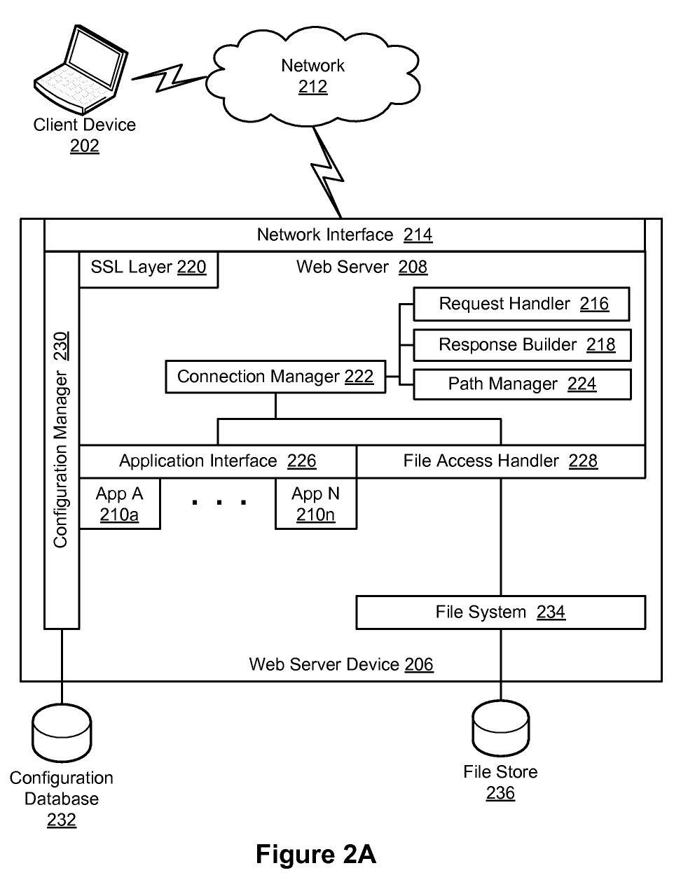

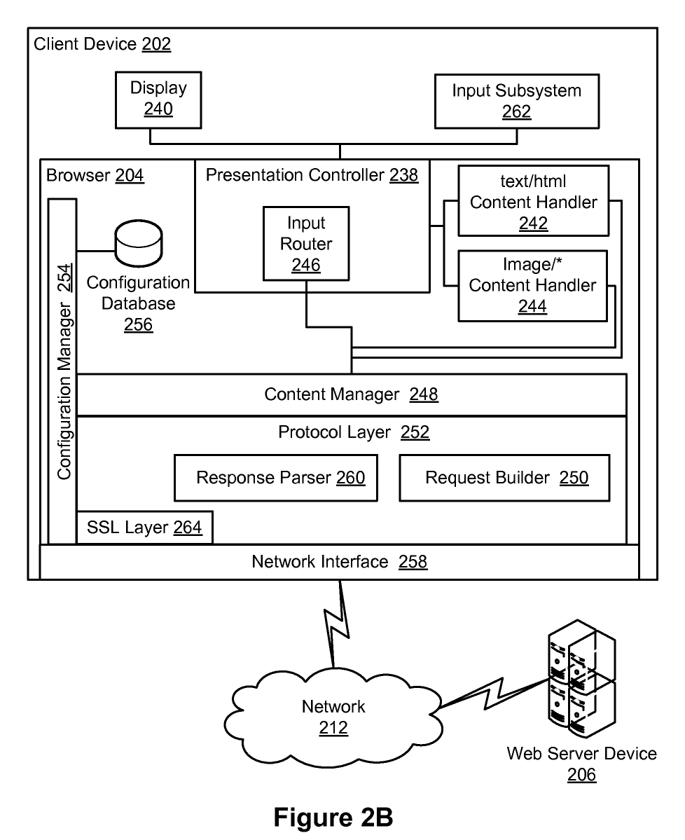

FIG. 1 is a flow diagram illustrating a method for providing for responding without at least one of scripts and cookies to requests based on unsolicited request header indications according to an exemplary embodiment of the subject matter described herein. FIG. 2A is a block diagram illustrating a system for providing for responding without at least one of scripts and cookies to requests based on unsolicited request header indications according to an exemplary embodiment of the subject matter described herein. The method illustrated in FIG. 1 can be carried out by, for example, the exemplary system illustrated in FIG. 2A.

With reference to FIG. 1, in block 102 a request is received from a client device 202, the request including a header with an unsolicited indicator for indicating whether at least one of cookies and scripts are accepted by the client device 202 in a response to the request. Accordingly, a system for providing for responding without at least one of scripts and cookies to requests based on unsolicited request header indications includes means for receiving a request from a client device 202, the request including a header with an unsolicited indicator for indicating whether cookies and/or scripts are accepted by the client device 202 in a response to the request. For example, as illustrated in FIG. 2A, a network interface component 214 is configured for receiving a request from a client device 202. The request includes a header with an unsolicited indicator for indicating whether cookies and/or scripts are accepted by the client device 202 in a response to the request. Client device 202 can be any network-enabled device, such as a computer or a handheld device.

The indicator is unsolicited by the receiver in the sense that the entity receiving the indicator does not need to send a message to the sender of the indicator in order to receive the indicator in a request. This allows a requester to provide this indicator so that the response associated with the request may be conformed to the indicator, rather than waiting to receive a request for the indicator in a response to an earlier request or other communication, then sending the indicator in response to the request for the indicator in a subsequent request. This approach can result in requiring not one but two request-response pairs, where the request for the indicator is included in the first response (from the first request-response pair) and the indicator is then provided in the second request (from the second request-response pair). According to the subject matter described herein, the requirement for the dual request-response pairs can be eliminated in favor of a single request-response pair in which the request includes the unsolicited header indicator.

Illustrated in FIG. 2A are the client device 202 and a web server device 206 that includes a web server 208 operating within an execution environment (not shown) of the web server device 206. The web server 208 is enabled to receive requests and send associated responses either on its own or in conjunction with one or more web applications 210a through 210n, collectively referred to as web applications 210. Client device 202 and the web server device 206 can communicate via a network 212, which may be, for example, a direct link, a local area network (LAN), an intranet, a wide area network (WAN) such as the Internet, and the like, or any combination thereof.

The request is received from the client device 202 and includes a header with a format that allows an indicator to be included. The indicator enables the receiver of the request to determine whether the sending client accepts at least one of scripts and cookies in a response. For example, a message can be sent from the client device 202 via the network 212 and received by the web server device 206 via the network interface component 214.

In the exemplary embodiment illustrated in FIG. 2A, the hypertext transfer protocol (HTTP) is used and the message can include an HTTP request such as an HTTP GET request. The network interface component 214 can be configured for receiving an HTTP request with an HTTP header. For example, an HTTP “Accept” header can be used to provide one or more multipurpose Internet mail extensions (MIME) types to inform the receiver of the types of data the requester is able or willing to process in a response. An example of a standard HTTP GET request message is illustrated in Example 1.

### EXAMPLE 1

GET www.mySite.us HTTP/1.1

Host: finance.myExample.us.com

User-Agent: Mozilla/5.0 (Windows; U; Windows NT 5.1; en-US; rv:1.8.0.7)

Gecko/20060909 Firefox/1.5.0.7

Accept: text/xml,application/xml,application/xhtml+xml,text/html;q=0.9,text/plain;q=0.8,image/png,image/jpeg

Accept-Language: en-us,en;q=0.5

Accept-Encoding: gzip,deflate

Accept-Charset: ISO-8859-1,utf-8;q=0.7,*;q=0.7

Keep-Alive: 300

Connection: keep-alive

Cookie: sessionid=AF13B0C

The headers illustrated are all standard headers documented in Internet engineering task force (IETF) document RFC 2616, which provides a specification for HTTP version 1.1.

In one aspect, two new headers may be provided by a client in an HTTP request to indicate whether scripts and/or cookies are allowed and, if allowed, the conditions under which they may be used. For example, script and cookie use may be restricted to certain sites or domains.

It should be noted that a header associated with cookies is already in use, but is limited because it is not capable of allowing unsolicited indications in a request to indicate that cookies are not accepted by the client in the subsequent response to the request. More particularly, IETF document RFC 2965 specifies that a server may use a “Set-Cookie” header in an HTTP response message to request or solicit a client to set and return a cookie. Also specified is a “Cookie” header for use by a client in responding to a “Set-Cookie” header received in a previous response associated with a server supporting the same uniform resource locator (URL) host domain. Neither RFC 2965 nor RFC 2616 describe a means for allowing a client to send an unsolicited indicator in a request to a receiver of the request informing the receiver that the client does or does not accept cookies from the receiver. Instead, the Set-Cookie header must first be received at the client in a previous response to another, earlier request which includes a cookie and value, which is the very thing the client may be prohibiting.

More particularly, the current mechanism for determining whether a requester accepts cookies requires receiving a request from a client, sending a response with a Set-Cookie header including a cookie and value, then waiting for the client to send a subsequent request and detecting whether the request includes a Cookie header including the cookie and value provided in the earlier Set-Cookie header in the response to the previous request. This method is inefficient and provides a responder with no indication as to why a requester does or does not accept cookies.

There are currently no headers known that relate to the acceptance of scripts.

The subject matter described herein can include two new exemplary headers. The first exemplary header is referred to as an “Accept-Scripts” header. The Accept-Scripts header can, for example, accept a value of “accepted” or “not_accepted.” Its use in a request is optional. In one aspect, the absence of this header indicates that scripts are accepted to support backward compatibility with current requesters that do not support the Accept-Scripts header. When present, a value of accepted indicates to a responder that scripts are accepted by the requester in the content of the associated response, and a value of not_accepted indicates that scripts are not accepted by the requester in the content of the associated response.

The second exemplary header is referred to herein as a “Cookie-Policy” header. The Cookie-Policy header can also, for example, accept a value of “accepted” or “not_accepted” and is optional. In one aspect, the absence of this header indicates nothing about whether cookies are accepted to support backward compatibility with current requesters that do not support the Cookie-Policy header. When present, a value of accepted indicates to a responder that cookies are accepted by the requester, and a value of not_accepted indicates that cookies are not accepted by the requester. This new header, in effect, can indicate to a responder whether a Set-Cookie header will be honored without the responder having to wait for a subsequent request from the requester to detect a Cookie header in the subsequent request.

Example 2 depicts an exemplary HTTP GET request modified to include the two proposed headers with values associated with the headers.

### EXAMPLE 2

GET www.mySite.us HTTP/1.1

Host: finance.myExample.us.com

User-Agent: Mozilla/5.0 (Windows; U; Windows NT 5.1; en-US; rv:1.8.0.7)

Gecko/20060909 Firefox/1.5.0.7

Accept: text/xml,application/xml,application/xhtml+xml,text/html;q=0.9,text/plain;q=0.8,image/png,image/jpeg

Accept-Language: en-us,en;q=0.5

Accept-Encoding: gzip,deflate

Accept-Charset: ISO-8859-1,utf-8;q=0.7,*;q=0.7

Accept-Scripts: accept

Keep-Alive: 300

Connection: keep-alive

Cookie-Policy: not_accepted

Cookie: sessionid=AF13B0C

In Example 2, the Accept-Scripts header has a value of accept, indicating that the client accepts scripts in a subsequent response. The Cookie-Policy header has a value of not_accepted, indicating that the client does not accept cookies in a subsequent response. Note also that the Cookie header is present and is providing a “sessionid” cookie identifier and value to the receiver of the request. This illustrates that the previous request from the client allowed cookies to be set in its associated response. However, the current request will not accept cookies in its associated response, but in compliance with its indication in the previous request, the requester is returning a cookie set provided in the previous request. It is not possible to return a cookie and indicate that cookies will no longer be accepted using current means.

In FIG. 2A, the request is received by the web server device 206 via the network 212 by the network interface component 214, which can process and remove various network protocol layer headers and trailers before the modified message is passed to an application layer protocol, such as HTTP, which can be represented by a request handler component 216 and a response builder component 218 in the example shown. In some cases, the message may be passed through an additional session layer protocol for additional services. For example, the web server device 206 can include a secure sockets layer (SSL) component 220 for supporting requests and responses using the secure HTTPS URL scheme. An HTTP request received by the web server 208 can be processed by the application protocol layer by the request handler component 216.

Returning to FIG. 1, in block 104 the header is processed for determining whether the cookies and/or scripts are accepted by the client device 202 based on the indicator. Accordingly, a system for providing for responding without at least one of scripts and cookies to requests based on unsolicited request header indications includes means for processing the header for determining whether the cookies and/or scripts are accepted by the client device 202 based on the indicator. For example, as illustrated in FIG. 2A, the request handler component 216 is configured for processing the header for determining whether the cookies and/or scripts are accepted by the client device 202 based on the indicator.

According to one aspect, the network interface component 214 is configured for receiving a request with a cookie and the request handler component 216 is configured for processing the header and determining that cookies are not accepted by the client device 202 based on the indicator. As mentioned above, it is not possible to return a cookie and indicate that cookies will no longer be accepted using current means.

In FIG. 2A, the request handler component 216 parses the request and may detect the “Cookie-Policy” header and/or the “Accept-Scripts” header. In one aspect, the request handler component 216 not only detects the header or headers, but also checks a value associated with the header or headers to determine its meaning. Once the meaning of the at least one header and its associated value is determined, the meaning is forwarded to a connection manager 222 for processing that in some cases includes forwarding a representation of the request to an application 210 for further processing.

In the current example, an HTTP request is associated with a transmission control protocol (TCP) connection created at the request of the client device 202 and accepted by the network interface component 214 of the web server device 206 as directed by the web server 208. The connection associated with the HTTP request can remain open to provide for full-duplex communication between the client device 202 and the web server 208. The HTTP request handler component 216 can be responsible for the input stream of the full-duplex connection from the perspective of the web server 208, while the HTTP response handler 218 can be responsible for the output stream of the connection from the web server 208 to the client device 202.

The connection manager 222 has responsibilities that can include, for example, determining a component of the web server 208 or web application 210a-n to which to direct a received request. The connection manager 222 can use a path manager 224 that when provided with at least a portion of the path part of the URI associated with a request can determine a web application from the web applications 210 available or a web server 208 component that can be responsible for handling requests associated with the at least a portion of the path part of the URI. The path manager 224 can use a table that associates at least a portion of a set of URI path parts with for example, a web application entry point, such as a java servlet through an application interface 226; or a web server 208 component, such as a file access handler 228. The table information used by the path manager 224 can be accessed via a configuration manager 230. The configuration manager 230 can be enabled to receive, store in a configuration database 232, and retrieve configuration data for components of web server 208 as well as web applications 210 and any web server 208 extensions or add-ons.

A variety of application interfaces are currently in use in addition to Java's J2EE platform interface between a J2EE container and a web server 208 including the well-known CGI interface. Most web servers supporting HTTP provide a file handler by default or as an add-on. A file handler is enabled to respond to HTTP GET, PUT, POST, and DELETE commands to operate on files and other static resources available to the web server 208 identified by a URI included in the request. The file handler 228 in the web server device 206 can use a file system 234 provided by and in conjunction with an operating system (not shown) of the web server device 206 to perform operations as directed on files in a file store 236, such as a hard-drive and other accessible resources provided through other available means on the web server device 206. Other services can be built into web servers in addition to file handlers.

In addition to routing requests, the connection manager 222 can gain access to information detected in the request by the request handler component 216 such as the URI, protocol version, the headers, and any content included in the message. In an alternate embodiment, the web server 208 can require an application 210 or web server component to parse HTTP requests and build HTTP responses. Accordingly, the detection of the “Cookie-Policy” and the “Accept-Scripts” headers may be performed by an application 210a-n, the web server 208 component, or an extension. The connection manager 222 can also provide access to the incoming and outgoing streams of the connection associated with the received HTTP request to allow a web application 210a-n or a server component to receive the content of the request. Access to the outgoing stream allows the receiving application 210a-n or a server component to generate a response with or without content in cooperation with response builder component 218.

Thus, the connection manager 222, via the application interface 226, can provide an application 210 or a web server 208 component the result of the determination of whether cookies and/or scripts are accepted in the response. In another aspect, the request handler component 216 can parse the request for detecting the headers and make the headers available to the identified application 210, or the web server 208 component or add-on. The application, in this case, can determine the meaning of the value of the “Script-Policy” and/or the “Accept-Scripts” header, if the request handler component 216 determines one or both are present in the request. Accordingly, the request handler component 216 may be implemented in several ways, as described above.

In another aspect, the request handler component 216 can be configured for processing a header dedicated for indicating whether cookies or whether scripts are accepted by the client device 202. In another aspect, the request handler component 216 is configured for processing a header dedicated for indicating whether cookies and whether scripts are accepted by the client device 202. That is, a single dedicated header with one or more indicators for both cookies and scripts may be used or separate dedicated headers for cookies and for scripts each with their own indicators may be used. In another aspect, one or more of the indicators can be included in another header that is currently in use, as one skilled in the art can appreciate. An exemplary single header solution provides a header “Security-Privacy” supporting the values “cookies”, “nocookies”, “scripts”, and/or “noscripts”. Keyword-value pairs may be used as an alternative to single word values.

In another aspect, each header can provide an indication associated only with the response to a request in which a header was included. Alternate embodiments may allow a header to provide an indication that covers a specified duration or the life of a session. If an indication spans the life of a session, a session ID can be identified in either the existing cookie headers (e.g., Set-Cookie and Cookies) or one of the new headers for cookies and scripts described above.

In another aspect, if no script or cookie policy data is provided, scripts and cookies are assumed to be allowed. This allows backwards compatibility with existing implementations.

In another aspect, consistent with the philosophy of HTTP, when an agent encounters a header it doesn't understand, the header is ignored in a preferred embodiment.

In another aspect, the request handler component 216 can be configured for processing the header for determining at least one of allowed and disallowed cookie-providing domains, at least one of allowed and disallowed cookie names, or at least one of allowed and disallowed cookie-providing domains and at least one of allowed and disallowed cookie names. For example, when the cookie indicator indicates accepted, a list of domains or cookie names may be provided within or with the indicator. Similarly, when the cookie indicator indicates not_accepted, a list of unsupported domains and cookie names may be listed. In addition, both lists may be provided together in either case. If a domain or cookie name is not specified and the not_accepted indicator is present, it can be assumed that any associated cookies are not accepted, in one aspect. Wildcards may also be used.

In another aspect, the request handler component 216 can be configured for determining at least one of allowed and disallowed cookie types. For example, cookies can be allowed or disallowed based on type or purpose, such as username, password, counter, and the like.

In another aspect, the request handler component 216 can be configured for determining from the header at least one of supported and unsupported scripting languages. For example, when the script indicator indicates accepted, a list of supported scripting languages may be provided with or within the indicator. Alternatively, when the script indicator indicates not_accepted, a list of unsupported script languages may be provided with or within the indicator. In addition, both lists may be provided together in either case. If a language is not specified and the not_accepted indicator is present, it is assumed that the language is not accepted, in one aspect.

In another aspect, the request handler component 216 can be configured for determining from the header at least one of allowed and disallowed script-based operations. For example, predefined identifiers can be used to restrict the operation of accepted scripts. In one example, a script indicator of “no-cookie-access” can indicate that scripts that are accepted will not be allowed access to any stored cookies, nor be able to create and store new cookies.

In another aspect, the request handler component 216 can be configured for determining an authorization for a script based on an electronic signature. For example, the indicator can be used to indicate whether a script must be signed and provide a list of authorized signers in order for a script to be accepted.

Returning to FIG. 1, in block 106 a response to the request is generated with or without the cookies and/or scripts based on the determination. Accordingly, a system for providing for responding without at least one of scripts and cookies to requests based on unsolicited request header indications includes means for generating a response to the request with or without the cookies and/or scripts based on the determination. For example, as illustrated in FIG. 2A, a response builder component 218 is configured for generating a response to the request with or without the cookies and/or scripts based on the determination.

For example, in a case where the determination in block 104 indicates cookies are accepted, one or more cookies may be included in the response sent to the client device 202. If the determination indicates that cookies are not accepted, cookies may not be included in the response. If cookies are included in the response when the indicator indicates cookies are not accepted, then the response can be rejected by the client device 202, by a layer of the responder's protocol stack, or by a proxy operating between the requester and responder.

In a case where the determination in block 104 indicates scripts are accepted, one or more scripts may be included in the response. If the determination indicates that scripts are not accepted, scripts may not be included in the response. If scripts are included in the response when the indicator indicates scripts are not accepted, the response can again be rejected by the client, by a layer of the responder's protocol stack, or by a proxy operating between the requester and responder.

For illustration purposes, the received message can be routed by the connection manager 222 to web application App A 210a, via application interface 226 based on a determination by the path manager 224 using at least a portion of the path of the URI included in the request. App A 210a can access information in the request including the URI, request headers, and any content that is included in the request via application interface 226. App A 210a, as is typical with most web applications, can determine the type of HTTP command, which in this example is a GET command. App A 210a can then invoke a GET command handler (not shown) that, based on the URI, performs an operation. App A 210a can use the results of the operation and initiate a process for building a response to the received request, where at least a portion of the operation results are designated as content for the response. App A 210, via application interface 226 and connection manager 222, can invoke response builder component 218 using parameters provided by App A 210a and/or information in the request retrieved from request handler component 216.

Based on a determined “Cookie-Policy” indication that cookies are not accepted, App A 210a, can modify a web page to be included in the response as content to add cookies as URL parameters to the URLs in the links in the web page. In web programming, this technique is known as URL rewriting and enables support for maintaining a session ID, for example, when support for cookies is not available. App A 210a can request response builder component 218 to add a “Set-Cookie” header via a call through the application interface and pass cookie identifiers and associated values.

Based on a determined “Accept-Scripts” indication that scripts are allowed, App A 210a can retrieve or generate a version of the requested web page that includes scripts. If the determined indication indicates that scripts are not allowed, App A 210a can retrieve or generate a version of the requested page that does not include scripts. Some applications can return a standard page indicating that the site will not operate without scripts.

App A 210a can use the application interface 226 to set any other headers needed and set an HTTP return code in a response built by the response builder component 218 based on requests from App A 210a via the application interface 226 via the connection manager 222.

Returning to FIG. 1, in block 108 the generated response is sent to the client device 202. Accordingly, a system for sending the generated response to the client device 202 includes means for sending the generated response to the client device 202. For example, as illustrated in FIG. 2A, the network interface component 214 is configured for sending the generated response to the client device 202.

For example, App A 210a can provide a signal to the response builder component 218 to forward the HTTP response to the network interface component 214 to forward the response or finish sending any remaining buffered portion of the response by closing the output stream of the associated connection. The output stream as mentioned earlier was provided to App A 210a via the application interface 226 when the connection manager 222 routed the received request to App A 210a.

The web server 208 can be configured to start transmitting the response to the client device 202 when App A 210a begins writing content to the output stream of the associated connection or can be configured to buffer the entire HTTP response, including the content, until an indication is received to send the data in a buffer (not shown). The indication that the response is complete and should be sent can be the closing of the output stream by App A 210a in the embodiment described. The output stream can be managed by the response builder component 218 and/or the network interface component 214, which together or singly can buffer the associated data and send the response.

After completing the setup of the HTTP response, App A 210a can add content to the response, if there is any, by writing the content to the output stream associated with the connection of the received request. In the example, App A 210a sends a web page as content as a result of App A's 210a operation in processing the request. App A 210a provides the MIME type, text.html, of the page, and writes the page to the output stream. This may cause the response builder component 218 to forward the response to the network interface component 214 to begin transmitting the HTTP response or the response builder component 218 may buffer the response until it receives a signal to flush its buffers. When App A 210a writes the final portion of the response content to the output stream, App A 210a closes the output stream to cause the response builder component 218 to forward the response to the network interface component 214 to begin transmitting the response or the remainder of the response to the client device 202. The response builder component 218 can forward the data to the network interface component 214 by passing one or more data buffers associated with a TCP port number to an interface enabling interaction with the network interface component 214. Sockets is an interface that can be used by applications and services in using a network interface component supporting the TCP/IP protocol.

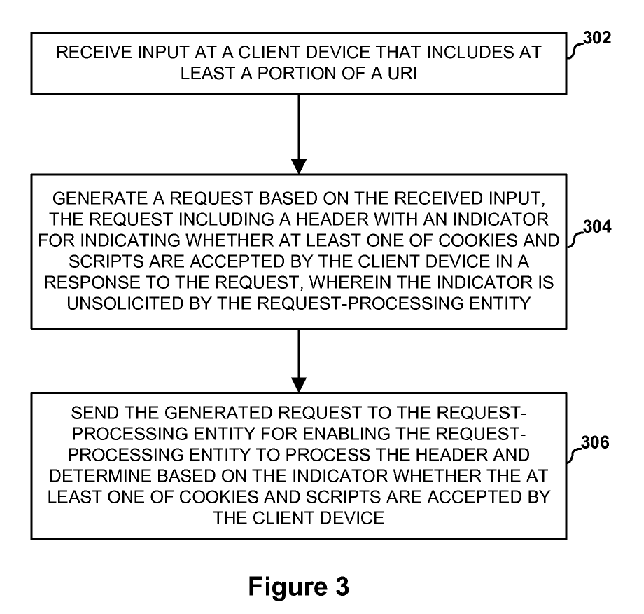

FIG. 2B and FIG. 3 illustrate exemplary systems and methods from the perspective of the sender of a request. FIG. 2B is a block diagram illustrating a system for providing for responding without at least one of scripts and cookies to requests based on unsolicited request header indications according to an exemplary embodiment of the subject matter described herein. FIG. 3 is a flow diagram illustrating a method for providing for responding without at least one of scripts and cookies to requests based on unsolicited request header indications according to another exemplary embodiment of the subject matter described herein. The method illustrated in FIG. 3 can be carried out by, for example, the exemplary system illustrated in FIG. 2B.

The client device 202 can include a browser 204 for sending requests and receiving associated responses. The browser 204 operates within an execution environment (not shown) of the client device 202.

With reference to FIG. 3, in block 302 input is received at the client device 202 that includes at least a portion of a URI. The at least a portion of the URI corresponds to a request-processing entity. Accordingly, a system for providing for responding without at least one of scripts and cookies to requests based on unsolicited request header indications includes means for receiving input that includes at least a portion of a URI at a client device 202, where at least a portion of the URI corresponds to a request-processing entity. For example, as illustrated in FIG. 2B, an input subsystem component 262 is configured for receiving input that includes at least a portion of a URI at a client device 202.

For example, the browser 204 in the client device 202 can receive a URL via an input subsystem component 262 of the client device 202 as presented on a display 240 in a location bar presented by the browser 204 under the direction of a presentation controller 238 of the browser 204. Alternatively, a URL and a specified HTTP command type can be received via the input subsystem component 262 as a result of, for example, receiving a selection of a link displayed on a web page on display 240 by presentation controller 238 as directed by one or more content handlers of the browser 204, such as an HTML content handler 242 and/or an image content handler 244. The input subsystem component 262 can pass a representation of the input received to an input router 246 included in the presentation controller 238. If the input is received via the location bar, the input router 246 can pass the input to a content manager 248 for processing. If the input is received via a web page, the input router 246 can pass the input to the content handler associated with a portion of the web page corresponding to the received input, such as the HTML content handler 242. The HTML content handler 242, for example, can pass the input received, including at least a portion of a URI to the content manager 248.

Returning to FIG. 3, in block 304 a request is generated based on the received input. The request includes a header with an indicator for indicating whether cookies and/or scripts are accepted by the client device 202 in a response to the request. The indicator is unsolicited by the request-processing entity. Accordingly, a system for providing for responding without at least one of scripts and cookies to requests based on unsolicited request header indications includes means for generating a request based on the received input, the request including a header with an indicator for indicating whether cookies and/or scripts are accepted by the client device 202 in a response to the request, where the indicator is unsolicited by the request-processing entity. For example, as illustrated in FIG. 2B, a request builder component 250 is configured for generating a request based on the received input. The request includes a header with an indicator for indicating whether cookies and/or scripts are accepted by the client device 202 in a response to the request. The indicator is unsolicited by the request-processing entity, as described above. That is, the header is not in response to a request from the receiver of the generated request for an indication whether cookies and/or scripts are accepted by the sender of the request.

The content manager 248 can route the received input based on the URI scheme of the at least a portion of a URI received. A complete URI can be generated from a partial URI based on a sender of the portion of the web page associated with the input received that resulted in a request to the content manager 248. Input received via the location bar can result in a complete URI being sent to the content manager 248 for building a request.

In one aspect, the request builder component 250 can be configured for generating an HTTP request with an HTTP header. In the current example, the scheme of the URI received by the content manager 248 is the HTTP scheme and the command indication received by the content manager 248 indicates an HTTP GET request is to be generated and sent. As a result, the content manager 248 routes the input including the URI and the command indication to a request builder component 250 of a protocol layer 252, which in this example is an HTTP protocol layer. The request builder component 250 generates an HTTP GET command based on the URI settings headers in the request as determined by the browser's 204 policy and configuration.

A configuration manager 254 manages configuration data for the browser 204 and can provide support for receiving configuration data as input and for storing configuration data in a configuration database 256. In the current example, configuration settings are supported that allow a user to configure whether the browser will accept cookies and/or scripts. Based on these settings retrieved via the configuration manager 254 and stored in the configuration database 256, the request builder component 250 can determine whether to include a header in the request indicating whether cookies and/or scripts are accepted in the response associated with the request.

In another aspect, the request builder component 250 can be configured for generating a request having a header dedicated for indicating whether cookies or whether scripts are accepted by the client device 202. In another aspect, the request builder component 250 can be configured for generating a request having a header dedicated for indicating whether cookies and whether scripts are accepted by the client device 202. As described above with regard to the web server device 206, separate headers or the same header can be used for indicating whether cookies are accepted and/or whether scripts are accepted.

Using a method described in U.S. Published patent application No. 2006/0014520, a user may control these header settings using scheme modifiers provided as a part of a URI entered via the location bar. Web developers may use scheme modifiers in links in web pages to indicate page preferences for these settings.

In one aspect, data affecting the settings received via the location bar override settings managed by the configuration manager 254 and settings managed by the configuration manager 254 override the preferences indicated by data included in a link of a web page. One skilled in the art can appreciate that settings can be maintained by the configuration manager 254 that are defaults for the browser, settings can be maintained on a domain basis, a URI pattern basis, or partial URI basis, and/or on a full URI basis. This list of options is not meant to be exhaustive.

The request builder component 250 can be configured for generating a request having an indicator indicating any of the additional information discussed above. For example, in one aspect, the request builder component 250 can be configured for generating a request having an indicator indicating at least one of allowed and disallowed cookie-providing domains, at least one of allowed and disallowed cookie names, or at least one of allowed and disallowed cookie-providing domains and at least one of allowed and disallowed cookie names. In another aspect, the request builder component 250 can be configured for determining at least one of allowed and disallowed cookie types. In another aspect, the request builder component 250 can be configured for generating a request having an indicator indicating at least one of supported and unsupported scripting languages. In another aspect, the request builder component 250 can be configured for generating a request having an indicator indicating at least one of allowed and disallowed script-based operations. In another aspect, the request builder component 250 can be configured for generating a request having an indicator indicating an authorization for a script based on an electronic signature. Each of these aspects is described above in further detail and their description is therefore not repeated here.

In another aspect, the request builder component 250 can be configured for generating a request that includes a cookie and an indicator indicating that cookies are not accepted by the client device 202 in a response to the request. For example, returning to the current example, the settings can indicate that scripts are allowed and cookies are not allowed for the URI of the request. A previous request from the same site, however, may have been allowed to set cookies. As a result, the request builder component 250 can add, for example, a “Cookies-Policy” header to the request with a value of “not_accepted”, an “Accept-Scripts” header to the request with a value of “accepted”, and can add a “Cookie” header including a cookie received in the response, which can include a “Set-Cookie” header when the response is associated with the previous request from the browser 204. This scenario is illustrated in Example 2 above.

Returning to FIG. 3, in block 306 the generated request is sent to the request-processing entity for enabling the request-processing entity to process the header and determine based on the indicator whether the cookies and/or scripts are accepted by the client device 202. Accordingly, a system for providing for responding without at least one of scripts and cookies to requests based on unsolicited request header indications includes means for sending the generated request to the request-processing entity for enabling the request-processing entity to process the header and determine based on the indicator whether the cookies and/or scripts are accepted by the client device 202. For example, as illustrated in FIG. 2B, a network interface component 258 is configured for sending the generated request to the request-processing entity. As described above, this enables the request-processing entity, such as web server device 206 to process the header and determine based on the indicator whether the cookies and/or scripts are accepted by the client device 202.

Returning again to the current example, the request builder component 250 can create a connection to the receiver by invoking either the network interface component 258, which can support, for example, TCP/IP, and can invoke a session layer protocol, such as SSL 264. In the current example, the network interface component 258 is called to create a connection to web server 208 in web server device 206 over network 212.

The network interface component 258 sends the HTTP GET request to the web server 208 using the connection created, which can include support by the request builder component 250. The processing of the HTTP GET request is described above, including a description of the generation and sending of a response conforming to the “Cookie-Policy” header value and the “Accept-Scripts” header value.

A response may be received by the client device 202 via network interface component 258 and provided to the protocol layer 252, such as an HTTP layer, via the connection created for sending the request. The response is handled in the protocol layer 252 by a response parser component 260. The response parser component 260 parses and validates the response. In one aspect, the response parser component 260 enforces the setting of the “Script-Policy” and “Accept-Script” headers. When a response does not conform, the response parser component 260 can discard the response and provide an error indication to the content manger 248, which can route the error indication to a content handler providing support for the MIME types of error indications. The content handler can present the error indication via the presentation controller 238 and display 240. In another case, the response parser component can cause the browser 204 to present a warning allowing a user to provide an indication as to whether the response should be fully processed, which can include presenting the content of the response.

For responses that do conform to the indicators provided in the request, the response parser component 260 can provide at least a portion of the response to the content manger 248 for routing to one or more content handlers providing support for the MIME type(s) of the response message content. The content handlers 242, 244 can present data that each receives according to its MIME type and relationships to other portions of a web page of which the data is a part.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, executable instructions of a computer program for carrying out the methods described herein can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

As used here, a “computer readable medium” can be any means that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), or (g) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

Thus, the subject matter described herein can be embodied in many different forms, and all such forms are contemplated to be within the scope of what is claimed. It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for providing for responding without at least one of scripts and cookies to requests based on unsolicited request header indications, the method comprising:
receiving a request from a client device, the request including a header with an unsolicited indicator for indicating whether at least one of cookies and scripts are accepted by the client device in a response to the request;
processing the header for determining whether the at least one of cookies and scripts are accepted by the client device based on the indicator;
generating a response to the request with or without the at least one of cookies and scripts based on the determination; and
sending the generated response to the client device.

2. The method of claim 1 wherein receiving a request includes receiving an HTTP request and processing the header for determining whether the at least one of cookies and scripts are accepted by the client device based on the indicator includes processing an HTTP header.

3. The method of claim 1 wherein receiving a request includes receiving a request that includes a cookie and processing the header for determining whether the at least one of cookies and scripts are accepted by the client device based on the indicator includes processing the header and determining that cookies are not accepted by the client device.

4. The method of claim 1 wherein processing the header for determining whether the at least one of cookies and scripts are accepted by the client device based on the indicator includes processing a header dedicated for indicating whether cookies or whether scripts are accepted by the client device.

5. The method of claim 1 wherein processing the header for determining whether the at least one of cookies and scripts are accepted by the client device based on the indicator includes processing a header dedicated for indicating whether cookies and whether scripts are accepted by the client device.

6. The method of claim 1 wherein processing the header for determining whether the at least one of cookies and scripts are accepted by the client device based on the indicator includes determining at least one of allowed and disallowed cookie-providing domains, at least one of allowed and disallowed cookie names, or at least one of allowed and disallowed cookie-providing domains and at least one of allowed and disallowed cookie names.

7. The method of claim 1 wherein processing the header for determining whether the at least one of cookies and scripts are accepted by the client device based on the indicator includes determining at least one of allowed and disallowed cookie types.

8. The method of claim 1 wherein processing the header for determining whether the at least one of cookies and scripts are accepted by the client device based on the indicator includes determining from the header at least one of supported and unsupported scripting languages.

9. The method of claim 1 wherein processing the header for determining whether the at least one of cookies and scripts are accepted by the client device based on the indicator includes determining from the header at least one of allowed and disallowed script-based operations.

10. The method of claim 1 wherein processing the header for determining whether the at least one of cookies and scripts are accepted by the client device based on the indicator includes determining an authorization for a script based on an electronic signature.

11. A method for providing for responding without at least one of scripts and cookies to requests based on unsolicited request header indications, the method comprising:
receiving input that includes at least a portion of a URI at a client device, wherein at least a portion of the URI corresponds to a request-processing entity;
generating a request based on the received input, the request including a header with an indicator for indicating whether at least one of cookies and scripts are accepted by the client device in a response to the request, wherein the indicator is unsolicited by the request-processing entity; and
sending the generated request to the request-processing entity for enabling the request-processing entity to process the header and determine based on the indicator whether the at least one of cookies and scripts are accepted by the client device.

12. The method of claim 11 wherein generating a request includes generating an HTTP request with an HTTP header.

13. The method of claim 11 wherein generating a request includes generating a request having a header dedicated for indicating whether cookies or whether scripts are accepted by the client device.

14. The method of claim 11 wherein generating a request includes generating a request having a header dedicated for indicating whether cookies and whether scripts are accepted by the client device.

15. The method of claim 11 wherein generating a request includes generating a request having an indicator indicating at least one of allowed and disallowed cookie-providing domains, at least one of allowed and disallowed cookie names, or at least one of allowed and disallowed cookie-providing domains and at least one of allowed and disallowed cookie names.

16. The method of claim 11 wherein generating a request includes generating a request having an indicator indicating whether the at least one of cookies and scripts are accepted by the client device based on the indicator includes determining at least one of allowed and disallowed cookie types.

17. The method of claim 11 wherein generating a request includes generating a request having an indicator indicating at least one of supported and unsupported scripting languages.

18. The method of claim 11 wherein generating a request includes generating a request having an indicator indicating at least one of allowed and disallowed script-based operations.

19. The method of claim 11 wherein generating a request includes generating a request having an indicator indicating an authorization for a script based on an electronic signature.

20. The method of claim 11 wherein generating a request includes generating a request that includes a cookie and an indicator indicating that cookies are not accepted by the client device in a response to the request.

21. A system for providing for responding without at least one of scripts and cookies to requests based on unsolicited request header indications, the system comprising:
means for receiving a request from a client device, the request including a header with an unsolicited indicator for indicating whether at least one of cookies and scripts are accepted by the client device in a response to the request and for sending a response to the request;
means for processing the header for determining whether the at least one of cookies and scripts are accepted by the client device based on the indicator; and
means for generating the response to the request with or without the at least one of cookies and scripts based on the determination.

22. A system for providing for responding without at least one of scripts and cookies to requests based on unsolicited request header indications, the system comprising:
a network interface component configured for receiving a request from a client device, the request including a header with an unsolicited indicator for indicating whether at least one of cookies and scripts are accepted by the client device in a response to the request and for sending a response to the request;
a request handler component configured for processing the header for determining whether the at least one of cookies and scripts are accepted by the client device based on the indicator; and
a response builder component configured for generating the response to the request with or without the at least one of cookies and scripts based on the determination.

23. The system of claim 22 wherein the network interface component is configured for receiving an HTTP request with an HTTP header.

24. The system of claim 22 wherein the network interface component is configured for receiving a request with a cookie and the request handler component is configured for processing the header and determining that cookies are not accepted by the client device based on the indicator.

25. The system of claim 22 wherein the request handler component is configured for processing a header dedicated for indicating whether cookies or whether scripts are accepted by the client device.

26. The system of claim 22 wherein the request handler component is configured for processing a header dedicated for indicating whether cookies and whether scripts are accepted by the client device.

27. The system of claim 22 wherein the request handler component is configured for processing the header for determining at least one of allowed and disallowed cookie-providing domains, at least one of allowed and disallowed cookie names, or at least one of allowed and disallowed cookie-providing domains and at least one of allowed and disallowed cookie names.

28. The system of claim 22 wherein the request handler component is configured for determining at least one of allowed and disallowed cookie types.

29. The system of claim 22 wherein the request handler component is configured for determining from the header at least one of supported and unsupported scripting languages.

30. The system of claim 22 wherein the request handler component is configured for determining from the header at least one of allowed and disallowed script-based operations.

31. The system of claim 22 wherein the request handler component is configured for determining an authorization for a script based on an electronic signature.

32. A system for providing for responding without at least one of scripts and cookies to requests based on unsolicited request header indications, the system comprising:
means for receiving input that includes at least a portion of a URI at a client device, wherein at least a portion of the URI corresponds to a request-processing entity;
means for generating a request based on the received input, the request including a header with an indicator for indicating whether at least one of cookies and scripts are accepted by the client device in a response to the request, wherein the indicator is unsolicited by the request-processing entity; and
means for sending the generated request to the request-processing entity for enabling the request-processing entity to process the header and determine based on the indicator whether the at least one of cookies and scripts are accepted by the client device.

33. A system for providing for responding without at least one of scripts and cookies to requests based on unsolicited request header indications, the system comprising:
an input subsystem component for receiving input that includes at least a portion of a URI at a client device, wherein at least a portion of the URI corresponds to a request-processing entity;
a request builder component for generating a request based on the received input, the request including a header with an indicator for indicating whether at least one of cookies and scripts are accepted by the client device in a response to the request, wherein the indicator is unsolicited by the request-processing entity; and
a network interface component configured for sending the generated request to the request-processing entity for enabling the request-processing entity to process the header and determine based on the indicator whether the at least one of cookies and scripts are accepted by the client device.

34. The system of claim 33 wherein the request builder component is configured for generating an HTTP request with an HTTP header.

35. The system of claim 33 wherein the request builder component is configured for generating a request having a header dedicated for indicating whether cookies or whether scripts are accepted by the client device.

36. The system of claim 33 wherein the request builder component is configured for generating a request having a header dedicated for indicating whether cookies and whether scripts are accepted by the client device.

37. The system of claim 33 wherein the request builder component is configured for generating a request having an indicator indicating at least one of allowed and disallowed cookie-providing domains, at least one of allowed and disallowed cookie names, or at least one of allowed and disallowed cookie-providing domains and at least one of allowed and disallowed cookie names.

38. The system of claim 33 wherein the request builder component is configured for determining at least one of allowed and disallowed cookie types.

39. The system of claim 33 wherein the request builder component is configured for generating a request having an indicator indicating at least one of supported and unsupported scripting languages.

40. The system of claim 33 wherein the request builder component is configured for generating a request having an indicator indicating at least one of allowed and disallowed script-based operations.

41. The system of claim 33 wherein the request builder component is configured for generating a request having an indicator indicating an authorization for a script based on an electronic signature.

42. The system of claim 33 wherein the request builder component is configured for generating a request that includes a cookie and an indicator indicating that cookies are not accepted by the client device in a response to the request.

43. A computer readable medium including a computer program, executable by a machine, for providing for responding without at least one of scripts and cookies to requests based on unsolicited request header indications, the computer program comprising executable instructions for:
receiving a request from a client device, the request including a header with an unsolicited indicator for indicating whether at least one of cookies and scripts are accepted by the client device in a response to the request;
processing the header for determining whether the at least one of cookies and scripts are accepted by the client device based on the indicator;
generating a response to the request with or without the at least one of cookies and scripts based on the determination; and
sending the generated response to the client device.

44. A computer readable medium including a computer program, executable by a machine, for providing for responding without at least one of scripts and cookies to requests based on unsolicited request header indications, the computer program comprising executable instructions for:
receiving input that includes at least a portion of a URI at a client device, wherein at least a portion of the URI corresponds to a request-processing entity;
generating a request based on the received input, the request including a header with an indicator for indicating whether at least one of cookies and scripts are accepted by the client device in a response to the request, wherein the indicator is unsolicited by the request-processing entity; and
sending the generated request to the request-processing entity for enabling the request-processing entity to process the header and determine based on the indicator whether the at least one of cookies and scripts are accepted by the client device.
